(19) United States
(12) Patent Application Publication
(10) Pub. No.: US 2024/0266570 A1
(43) Pub. Date: Aug. 8, 2024

(54) HUMIDITY RESPONSIVE ENERGY HARVESTER AND METHOD FOR MANUFACTURING THE SAME

(71) Applicant: KOREA UNIVERSITY RESEARCH AND BUSINESS FOUNDATION, Seoul (KR)

(72) Inventors: Won Joon CHOI, Seoul (KR); Byung Seok SEO, Seoul (KR)

(21) Appl. No.: 18/560,994

(22) PCT Filed: Dec. 1, 2021
(86) PCT No.: PCT/KR2021/017991

§ 371 Date: Nov. 15, 2023

(30) Foreign Application Priority Data
Dec. 1, 2020 (KR) 10-2020-0165456

(51) Int. Cl. H01M 8/1004; H01M 4/92; H01M 8/10; H01M 8/1027; H01M 8/1032

(52) U.S. Cl. CPC H01M 8/1004; H01M 4/923; H01M 4/926; H01M 8/1027; H01M 8/1032; H01M 2008/1095; H01M 2300/0082

(57) ABSTRACT

Provided is a humidity responsive energy harvester. The humidity responsive energy harvester may include: a substrate structure including a carbon fiber; a first harvesting structure disposed on the substrate structure and including a polymer that changes a concentration of hydrogen ions in response to humidity; and a second harvesting structure disposed on the first harvesting structure and including a carbon fiber coated with an active material which includes a composite of a transition metal and an oxide of the transition metal, wherein when the polymer in the first harvesting structure changes the concentration of hydrogen ions in response to the humidity, energy may be generated due to a difference in redox reaction of the second harvesting structure.

### TECHNICAL FIELD

The present invention relates to a humidity responsive energy harvester and a method for manufacturing the same, and more specifically, to a humidity responsive energy harvester for generating energy through a difference in redox reaction of a harvesting structure in response to humidity, and a method for manufacturing the same.

### BACKGROUND ART

An energy storage system (ESS) is attracting attention as a core technology of Smart Grid that temporarily stores the generated power to efficiently supply energy to the best places and time zones for requiring the power. The ESS has a battery type ESS and a non-battery type ESS according to a method for storing energy.

For the former case, a sodium sulfur battery (NaS)/redox flow battery (RFB)/lithium ion battery (LIB), and the like are used. For the latter case, a pumped-storage hydroelectricity (PH)/compressed air energy storage (CAES)/flywheel method, which is a physical storage method, superconducting magnetic energy storage (SEMS)/super-capacitor, which is an electromagnetic storage method, and the like are used.

Recently, an energy storage material technology using fibers and composite materials, an energy harvesting technology for converting heat, vibration, or the like into electrical energy to store the electrical energy, an energy storage technology using a phase change material (PCM), and the like have been developed.

The energy harvesting technology is not a technology that directly stores energy, but is a technology that can efficiently obtain energy, thereby exhibiting the same effect as the energy storage. In particular, as a green energy harvesting technology and an intelligent storage material technology are developed, these technologies are developing into an intelligent fiber technology having wearable energy harvesting/storage functions.

### DISCLOSURE

### Technical Problem

One technical problem to be solved by the present invention is to provide a humidity responsive energy harvester capable of harvesting energy through a palladium/palladium oxide/carbon composite and a method for manufacturing the same.

Another technical problem to be solved by the present invention is to provide a humidity responsive energy harvester manufactured through a joule-heating process and a method for manufacturing the same.

Still another technical problem to be solved by the present invention is to provide a humidity responsive energy harvester capable of controlling a chemical composition and a physical structure of a harvesting structure by controlling conditions (e.g., power magnitude, power time duration, etc.) of a joule-heating process, and a method for manufacturing the same.

Still another technical problem to be solved by the present invention is to provide a humidity responsive energy harvester capable of improving energy generation efficiency by controlling a chemical composition and a physical structure of the harvesting structure, and a method for manufacturing the same.

The technical problems to be solved by the present invention are not limited to those described above.

### Technical Solution

In order to solve the technical problems, the present invention provides a humidity responsive energy harvester.

According to one embodiment, the humidity responsive energy harvester may comprise: a substrate structure including a carbon fiber; a first harvesting structure disposed on the substrate structure and including a polymer that changes a concentration of hydrogen ions in response to humidity; and a second harvesting structure disposed on the first harvesting structure and including a carbon fiber coated with an active material which includes a composite of a transition metal and an oxide of the transition metal, wherein when the polymer in the first harvesting structure changes the concentration of hydrogen ions in response to the humidity, energy is generated due to a difference in redox reaction of the second harvesting structure.

According to one embodiment, the active material may include a plurality of oxides of the transition metal, which have mutually different oxidation numbers, and a content of the oxide of the transition metal, which has a relatively high oxidation number, increases, an amount of generated energy may increase.

According to one embodiment, the active material may include palladium (Pd), palladium divalent oxide (PdO), and palladium tetravalent oxide (PdO₂), and as a content of the palladium tetravalent oxide (PdO₂) increases, the amount of generated energy may increase.

According to one embodiment, the carbon fiber in the second harvesting structure may have a porous structure, and as porosity of the carbon fiber increases, an amount of generated energy may increase.

According to one embodiment, the polymer may include poly(4-styrenesulfonic acid) (PSSH).

In order to solve the above technical problem, the present invention provides a method for manufacturing a humidity responsive energy harvester.

According to one embodiment, the method for manufacturing a humidity responsive energy harvester may comprise: preparing a first harvesting structure that includes a polymer that changes a concentration of hydrogen ions in response to humidity; joule-heating a base structure including a carbon fiber coated with a precursor material including a transition metal, thereby preparing a second harvesting structure having a chemical composition and a physical structure of a base structure in which a chemical composition and a physical structure of the base structure are changed due to the precursor material; and bonding a substrate structure that includes the carbon fiber, the first harvesting structure, and the second harvesting structure such that the first harvesting structure is disposed between the substrate structure and the second harvesting structure.

According to one embodiment, the preparing of the second harvesting structure may include: a primary joule-heating step of changing the chemical composition of the base structure; and a secondary joule-heating step of changing the physical structure of the base structure, wherein in the primary joule-heating step, the precursor material coated on the carbon fiber in the base structure is oxidized to be changed into an active material including a composite of the transition metal and an oxide of the transition metal, and wherein in the secondary joule-heating step, a liquefied oxide of the transition metal penetrates into the carbon fiber so that a pore is formed in the carbon fiber.

According to one embodiment, in the secondary joule-heating step, as a magnitude of power applied to the base structure and a time duration of the power are controlled, porosity of the carbon fiber may be controlled.

According to one embodiment, the primary joule-heating step may be performed prior to the secondary joule-heating step.

According to one embodiment, the active material may include a plurality of oxides of the transition metal, which have mutually different oxidation numbers.

According to one embodiment, the preparing of the second harvesting structure may include: preparing a carbon fiber sheet; providing the precursor material on the carbon fiber sheet to produce the base structure in which a surface of the carbon fiber sheet is coated with the precursor material; and joule-heating the base structure by forming electrodes on both ends of the base structure, and applying power to the electrodes formed on the both ends.

According to one embodiment, the transition metal may include palladium (Pd), and the precursor material may include palladium nitrate (Pd(NO₃)₂).

### Advantageous Effects

According to the embodiment of the present invention, the humidity responsive energy harvester may include: a substrate structure including a carbon fiber; a first harvesting structure disposed on the substrate structure and including a polymer (e.g., PSSH) that changes a concentration of hydrogen ions in response to humidity; and a second harvesting structure disposed on the first harvesting structure and including a carbon fiber coated with an active material which includes a composite of a transition metal (e.g., palladium) and an oxide (e.g., palladium oxide) of the transition metal, wherein when the polymer in the first harvesting structure changes the concentration of hydrogen ions in response to the humidity, energy may be generated due to a difference in redox reaction of the second harvesting structure.

In addition, in the second harvesting structure of the humidity responsive energy harvester, a base structure including a carbon fiber coated with the precursor material (e.g., palladium nitrate), which includes the transition metal (e.g., palladium), may be formed by joule-heating, and a magnitude of power applied to the base structure and a time duration of the power may be controlled. Accordingly, a content of the oxide (e.g., palladium tetravalent oxide (PdO₂)) of the transition metal, which has a relatively high oxidation number, in the active material of the second harvesting structure may increase, and porosity of the carbon fiber may increase. Therefore, an amount of generated energy of the humidity responsive energy harvester may be increased.

### DESCRIPTION OF DRAWINGS

FIG. 1 is a view showing a process of preparing a first harvesting structure in a method for manufacturing a humidity responsive energy harvester according to an embodiment of the present invention.

FIG. 2 is a view showing a process of preparing a second harvesting structure in the method for manufacturing a humidity responsive energy harvester according to the embodiment of the present invention.

FIG. 3 is a view showing the humidity responsive energy harvester according to the embodiment of the present invention.

FIG. 4 is a view showing a mechanism of the humidity responsive energy harvester according to the embodiment of the present invention.

FIG. 5 is an image and a graph for confirming a chemical composition of the second harvesting structure of the humidity responsive energy harvester according to the embodiment of the present invention.

FIGS. 6 to 8 are images showing a change in a surface of a carbon fiber according to joule-heating conditions in a process of producing the second harvesting structure of the humidity responsive energy harvester according to the embodiment of the present invention.

FIG. 9 is a graph showing a change in porosity of the carbon fiber according to the joule-heating conditions in the process of producing the second harvesting structure of the humidity responsive energy harvester according to the embodiment of the present invention.

FIG. 10 is a graph showing a change in a chemical composition according to the joule-heating conditions in the process of producing the second harvesting structure of the humidity responsive energy harvester according to the embodiment of the present invention.

FIG. 11 is a graph showing a change in a chemical composition of the second harvesting structure of the humidity responsive energy harvester according to the embodiment of the present invention.

FIG. 12 is a view showing a change in a chemical composition according to energy applied to a base structure during the process of producing the second harvesting structure of the humidity responsive energy harvester according to the embodiment of the present invention.

FIG. 13 is a graph showing a change in electrical characteristics according to the energy applied to the base structure during the process of producing the second harvesting structure of the humidity responsive energy harvester according to the embodiment of the present invention.

FIGS. 14 and 15 are views showing an influence of stepwise joule-heating during the process of producing the second harvesting structure of the humidity responsive energy harvester according to the embodiment of the present invention.

FIG. 16 is a graph showing a change in characteristics according to a humidity environment of the humidity responsive energy harvester according to the embodiment of the present invention.

FIG. 17 is a graph showing reliability of the humidity responsive energy harvester according to the embodiment of the present invention.

FIG. 18 is a graph showing temperature dependence and stability of the humidity responsive energy harvester according to the embodiment of the present invention.

FIG. 19 is a graph showing a temperature profile according to a power application time during the process of producing the second harvesting structure of the humidity responsive energy harvester according to the embodiment of the present invention.

FIG. 20 shows an x-ray photoelectron spectroscope (XPS) peak decomposition of the chemical composition of the second harvesting structure of the humidity responsive energy harvester according to the embodiment of the present invention.

FIG. 21 is a graph of comparing the base structure according to the embodiment of the present invention with a base structure according to a comparative example.

FIG. 22 is a graph of testing solution environment dependence of the humidity responsive energy harvester according to the embodiment of the present invention.

FIG. 23 is a graph showing a change in electrical characteristics and a change in a chemical composition according to the magnitude of power applied to the base structure and a joule-heating time during the process of producing the second harvesting structure of the humidity responsive energy harvesting according to the embodiment of the present invention.

FIG. 24 is a graph showing electrical characteristics of a carbon fiber sheet of the humidity responsive energy harvester according to the embodiment of the present invention.

FIG. 25 is graphs of comparing, according to a joule-heating cycle, chemical compositions of the second harvesting structure of the humidity responsive energy harvester according to the embodiment of the present invention.

### MODE FOR INVENTION

Hereinafter, preferred embodiments of the present invention will be described in detail with reference to the accompanying drawings. However, the present invention may be embodied in different forms and should not be construed as limited to the embodiments set forth herein. Rather, the embodiments are provided so that this disclosure will be thorough and complete, and will fully convey the scope of the present invention to those skilled in the art.

In the present specification, it will be understood that when an element is referred to as being “on” another element, it can be formed directly on the other element or intervening elements may be present. In the drawings, the thicknesses of layers and regions are exaggerated for clarity.

In addition, it will be also understood that although the terms first, second, third, etc. may be used herein to describe various elements, these elements should not be limited by these terms. These terms are only used to distinguish one element from another element. Thus, a first element in some embodiments may be termed a second element in other embodiments without departing from the teachings of the present invention. Embodiments explained and illustrated herein include their complementary counterparts. As used herein, the term “and/or” includes any and all combinations of one or more of the associated listed elements.

The singular expression also includes the plural meaning as long as it does not differently mean in the context. In addition, the terms “comprise”, “have” etc., of the description are used to indicate that there are features, numbers, steps, elements, or combinations thereof, and they should not exclude the possibilities of combination or addition of one or more features, numbers, operations, elements, or a combination thereof. Furthermore, it will be understood that when an element is referred to as being “connected” or “coupled” to another element, it may be directly connected or coupled to the other element or intervening elements may be present.

In addition, when detailed descriptions of related known functions or constitutions are considered to unnecessarily cloud the gist of the present invention in describing the present invention below, the detailed descriptions will not be included.

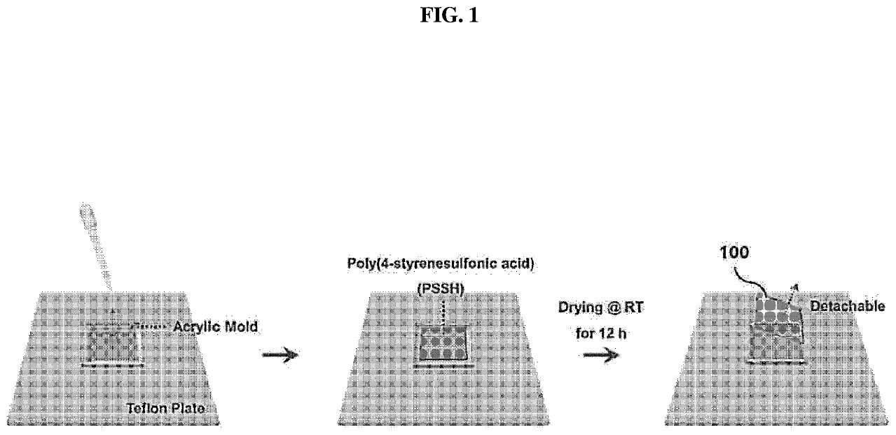

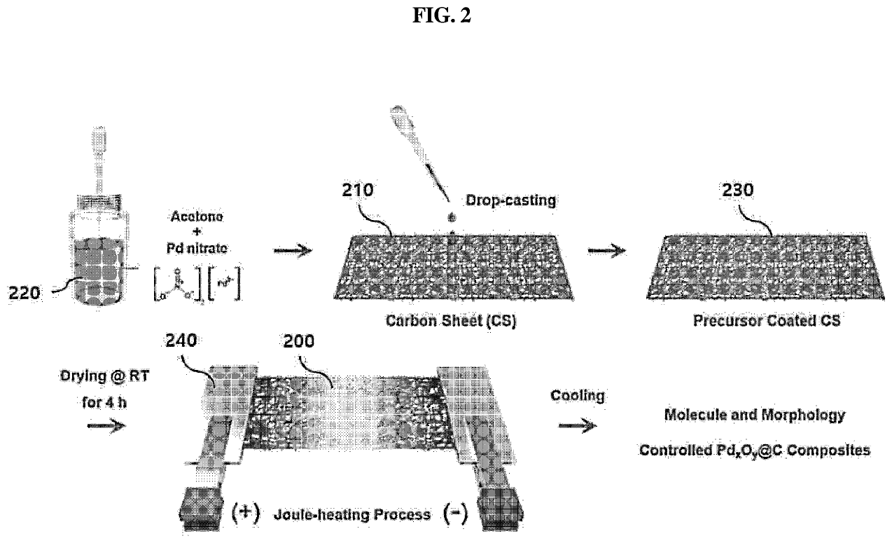

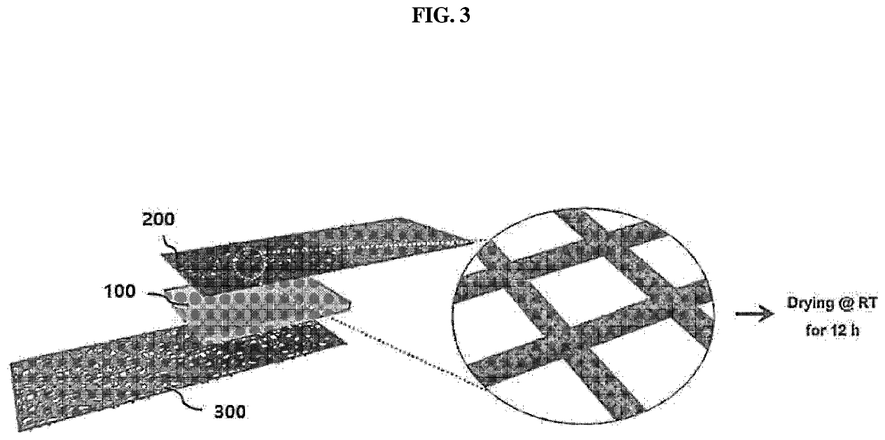

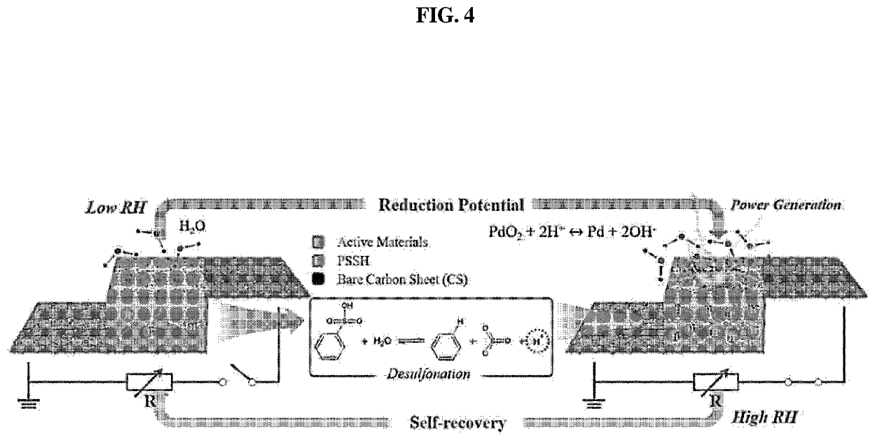

FIG. 1 is a view showing a process of preparing a first harvesting structure in a method for manufacturing a humidity responsive energy harvester according to an embodiment of the present invention, FIG. 2 is a view showing a process of preparing a second harvesting structure in the method for manufacturing a humidity responsive energy harvester according to the embodiment of the present invention, FIG. 3 is a view showing the humidity responsive energy harvester according to the embodiment of the present invention, and FIG. 4 is a view showing a mechanism of the humidity responsive energy harvester according to the embodiment of the present invention.

Referring to FIG. 1, a first harvesting structure 100 may be prepared. According to one embodiment, the first harvesting structure 100 may include a polymer that changes a concentration of hydrogen ions in response to humidity. For example, the polymer may include poly(4-styrenesulfonic acid) (PSSH) ((C₈H₈O₃S)ₙ).

More specifically, a Teflon plate having an acrylic mold formed thereon and a source solution in which water (H₂O) and PSSH having a concentration of 18 wt % are mixed may be prepared. After the source solution is provided into the acrylic mold, the source solution may be dried for 12 hours to remove water (H₂O) in the source solution. Accordingly, the first harvesting structure 100 having a shape of the acrylic mold may be produced.

Referring to FIG. 2, a second harvesting structure 200 may be prepared. The step of preparing the second harvesting structure 200 may include: a step of preparing a carbon fiber sheet 210 and a precursor solution 220; a step of producing a base structure 230 by coating the carbon fiber sheet 210 with the precursor solution 220; and a step of producing a second harvesting structure 220 by joule-heating the base structure.

According to one embodiment, the precursor solution 220 may be a solution in which a precursor material is mixed with a solvent. For example, the precursor material may include a transition metal. The transition metal may include palladium (Pd). Specifically, the precursor material may be palladium nitrate (Pd(No₃)₂). For example, the solvent may include acetone having a concentration of 1 M.

More specifically, the carbon fiber sheet may be coated with a precursor solution in which acetone having the concentration of 1 M and palladium nitrate (Pd(NO₃)₂) are mixed to produce the base structure 230. After the base structure 230 is dried for 4 hours, a titanium plate electrode 240 is attached to both ends of the base structure 230, and power is applied through the attached titanium plate electrode 240, thereby producing the second harvesting structure 200.

According to one embodiment, the step of producing the second harvesting structure 200 by joule-heating the base structure 230 may include: a primary joule-heating step of changing a chemical composition of the base structure 230; and a secondary joule-heating step of changing a physical structure of the base structure. The primary joule-heating step may be performed prior to the secondary joule-heating step.

More specifically, when power is primarily applied to the base structure 230, the precursor material (e.g., Pd(NO₃)₂) coated onto the carbon fiber of the base structure 230 may be oxidized according to the following Chemical Formula 1.

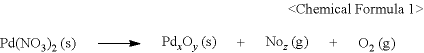

Accordingly, a composite of palladium metal (Pd metallic) and palladium oxide (PdₓO_{y}) (x, y>0) may be formed on a surface of the carbon fiber of the base structure 230. That is, when the base structure 230 is primarily joule-heated, the material coated onto the surface of the carbon fiber of the base structure 230 may be changed from palladium nitrate (Pd(NO₃)₂) to the composite of a palladium metal (Pd metallic) and palladium oxide (PdₓO_{y}).

The composite of the palladium metal (Pd metallic) and the palladium oxide (PdₓO_{y}) may be defined as an active material. The palladium oxide (PdₓO_{y}) may include a plurality of palladium oxides having mutually different oxidation numbers. For example, the palladium oxide (PdₓO_{y}) may include a palladium divalent oxide (PdO) and a palladium tetravalent oxide (PdO₂).

That is, the active material may include the palladium metal (Pd metallic), the palladium divalent oxide (PdO), and the palladium tetravalent oxide (PdO₂). According to one embodiment, as a content of the palladium tetravalent oxide (PdO₂) in the active material increases, an amount of generated energy of the humidity responsive energy harvester, which will be described below, may increase. In the primary joule-heating step, a composition in the active material may be controlled by controlling a magnitude of power applied to the base structure 230 and a time duration of the power.

When the power is primarily applied to the base structure 230 after the chemical composition of the base structure 230 is changed, the palladium oxide (PdₓO_{y}) coated onto the carbon fiber may be liquefied. Since the liquefied palladium oxide (PdₓO_{y}) is in a high temperature (e.g., 1000° C. or higher) state, it may penetrate into the carbon fiber. Accordingly, a plurality of pores may be formed in the carbon fiber of the base structure 230 by the liquefied palladium oxide (PdₓO_{y}). The formation of the pore in the carbon fiber may be accelerated according to the following <Chemical Formula 2> and <Chemical Formula 3>.

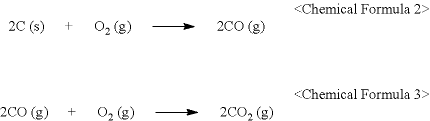

According to one embodiment, in the secondary joule-heating step, as the magnitude of power applied to the base structure 230 and the time duration of the power are controlled, porosity of the carbon fiber may be controlled. When the porosity of the carbon fiber increases, the total surface area of the second harvesting structure 200 increases, so that the amount of generated energy of the humidity responsive energy harvester, which will be described below, may increase.

For example, in the secondary joule-heating step, the base structure 230 may be joule-heated at power of 200 W for a time of longer than 0.3 s and shorter than 1.5 s. In this case, the carbon fiber may have a maximum porosity. In contrast, when the magnitude of power applied to the base structure 230 is changed, the time duration of the power may also be controlled differently. For example, the base structure 230 may be joule-heated at power of 100 W for a time of longer than 0.4 s and shorter than 1 s. For another example, the base structure 230 may be joule-heated at power of 300 W for a time of longer than 0.2 s and shorter than 0.4 s.

That is, the base structure 230 may be joule-heated in stages (primary joule-heating—secondary joule-heating), so that the surface of the carbon fiber may be coated with the active material (palladium metal/palladium oxide composite), and the second harvesting structure having a plurality of pores formed in the carbon fiber may be produced. In contrast, when the second harvesting structure is produced through the single joule-heating process, the active material and the pore are not sufficiently formed, resulting in a low energy generation rate of the humidity responsive energy harvester, which will be described below.

Referring to FIG. 3, a substrate structure 300 may be prepared. According to one embodiment, the substrate structure 300 may include a carbon fiber. The first harvesting structure 100, the second harvesting structure 200, and the substrate structure 300 may be bonded such that the first harvesting structure 100 is disposed between the substrate structure 300 and the second harvesting structure 200. Accordingly, the humidity responsive energy harvester according to the embodiment may be manufactured.

Referring to FIG. 4, when the humidity responsive energy harvester is exposed to an environment (e.g., humidity environment) in which water (H₂O) and hydrogen (H) exist, the active material (e.g., a palladium metal/palladium oxide composite) of the second harvesting structure 200 may be generated with a potential through reversible redox reaction as in the following <Chemical Formula 4> and <Chemical Formula 5>.

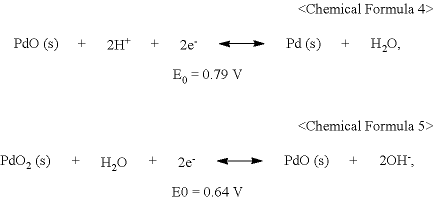

In addition, when an environment (e.g., humidity environment) around the humidity responsive energy harvester is changed, the concentration of hydrogen ions in the polymer (e.g., PSSH) of the first harvesting structure 100 may be changed, and a difference in redox reaction of the active material (e.g., palladium metal/palladium oxide composite) in the second harvesting structure 200 may occur according to the change in the concentration of hydrogen ions in the polymer (e.g., PSSH). Accordingly, energy is generated due to the potential difference.

As a result, the humidity responsive energy harvester according to the embodiment of the present invention may include: the substrate structure 300 including a carbon fiber; the first harvesting structure 100 disposed on the substrate structure 300 and including the polymer (e.g., PSSH) that changes a concentration of hydrogen ions in response to humidity; and a second harvesting structure 200 disposed on the first harvesting structure 100 and including a carbon fiber coated with the active material which includes a composite of the transition metal and an oxide (e.g., palladium oxide) of the transition metal, in which when the polymer in the first harvesting structure 200 changes the concentration of hydrogen ions in response to the humidity, energy is generated due to a difference in redox reaction of the second harvesting structure 200.

In addition, in the second harvesting structure 200 of the humidity responsive energy harvester, the base structure 230 including a carbon fiber coated with the precursor material (e.g., palladium nitrate), which includes the transition metal (e.g., palladium), may be formed by joule-heating, and a magnitude of power applied to the base structure 230 and a time duration of the power may be controlled. Accordingly, the content of the oxide (e.g., palladium tetravalent oxide, PdO₂) of the transition metal, which has a relatively high oxidation number, in the active material of the second harvesting structure 200, may be increased, and the porosity of the carbon fiber may be increased. Therefore, the amount of generated energy of the humidity responsive energy harvester may be increased.

Hereinabove, the humidity responsive energy harvester and the method for manufacturing the same according to the embodiment of the present invention have been described. Hereinafter, specific experimental examples and characteristic evaluation results of the humidity responsive energy harvester and the method for manufacturing the same according to the embodiment of the present invention will be described.

### Manufacture of Humidity Responsive Energy Harvester According to Embodiment

A Teflon plate having an acrylic mold formed thereon and a source solution in which water (H₂O) and PSSH having a concentration of 18 wt % are mixed were prepared. The source solution was dried for 12 hours after being provided into an acrylic mold to produce a first harvesting structure having a shape of the acrylic mold.

A carbon fiber sheet was coated with a precursor solution in which acetone having a concentration of 1 M and palladium nitrate (Pd(NO₃)₂) are mixed to produce a base structure. After the base structure was dried for 4 hours, the titanium plate electrode was attached to both ends of the base structure and power was applied through the attached titanium plate electrode, thereby producing a second harvesting structure.

Finally, the carbon fiber sheet was prepared, and the first harvesting structure, the second harvesting structure, and the carbon fiber sheet were boded such that the first harvesting structure is disposed between the prepared carbon fiber sheet and the second harvesting structure, thereby manufacturing a humidity responsive energy harvester according to the embodiment.

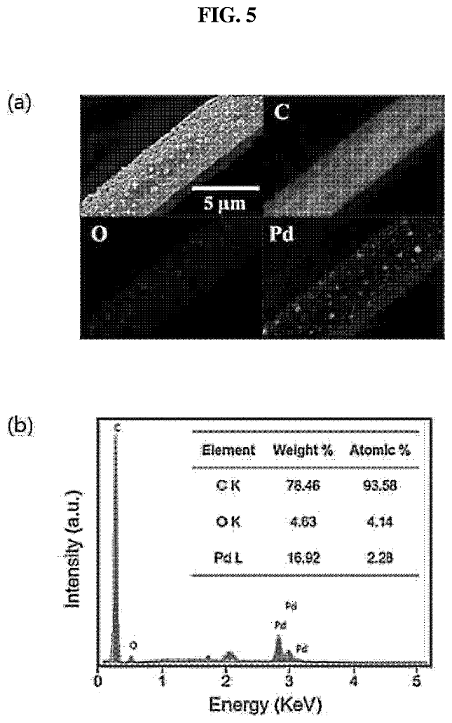

FIG. 5 is an image and a graph for confirming a chemical composition of the second harvesting structure of the humidity responsive energy harvester according to the embodiment of the present invention.

Referring to FIGS. 5(a) and 5(b), FIG. 5(a) shows an energy dispersive X-ray spectroscopy (EDS) mapping image for the second harvesting structure of the humidity responsive energy harvester according to the embodiment, and FIG. 5(b) shows a graph of elemental evolution analysis. As a specific experimental condition, the second harvesting structure was produced by applying power of 100 W to the base structure for 10 s.

As can be seen from FIGS. 5(a) and 5(b), the second harvesting structure of the humidity responsive energy harvester included palladium metal (Pd metallic), palladium divalent oxide (PdO), and palladium tetravalent oxide (PdO₂).

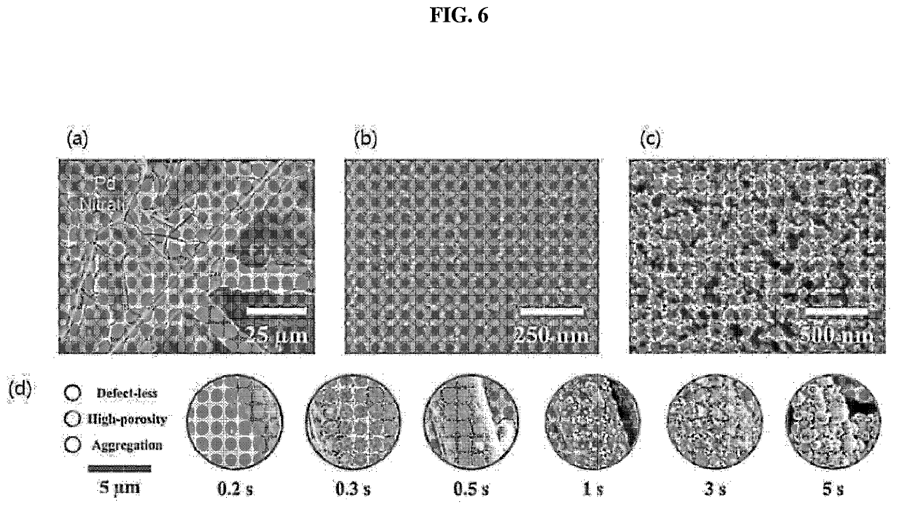

FIGS. 6 to 8 are images showing a change in a surface of a carbon fiber according to joule-heating conditions in a process of producing the second harvesting structure of the humidity responsive energy harvester according to the embodiment of the present invention.

Referring to FIG. 6(a), a scanning electron microscopy (SEM) image of a base structure, which is prepared in the process of producing the second harvesting structure of the humidity responsive energy harvester according to the embodiment, is shown. As can be seen in FIG. 6(a), the base structure has palladium nitrate (Pd nitrate) that is coated onto the surface of the carbon fiber.

Referring to FIG. 6(b), an SEM image of a second harvesting structure produced by applying power of 100 W to the base structure for 0.05 s is shown, and referring to FIG. 6(c), an SEM image of a second harvesting structure produced by applying power of 100 W to the base structure for 0.4 s is shown.

As can be seen from FIGS. 6(b) and 6(c), the second harvesting structure, which was produced by applying power of 100 W to the base structure for 0.05 s, had no pore in the carbon fiber, but the second harvesting structure, which was produced by applying power of 100 W to the base structure for 0.4 s, had a plurality of pores in the carbon fiber.

Referring to FIG. 6(d), SEM images of second harvesting structures, which are produced by applying power of 100 W to the base structure for 0.2 s, 0.3 s, 0.5 s, 1 s, 3 s, and 5 s, respectively, are shown. As can be seen in FIG. 6(d), no pore was formed in the carbon fiber when the power of 100 W was applied for a relatively short time (0.2 s). In addition, it was confirmed that when the power of 100 W was applied for a relatively long time (1 s, 3 s, and 5 s), palladium nitrate coated onto the surface of the carbon fiber was aggregated, so that no pore was formed. On the other hand, when the power of 100 W was applied for a time of 0.3 s and 0.5 s, it was confirmed that a plurality of pores were formed in the surface of the carbon fiber.

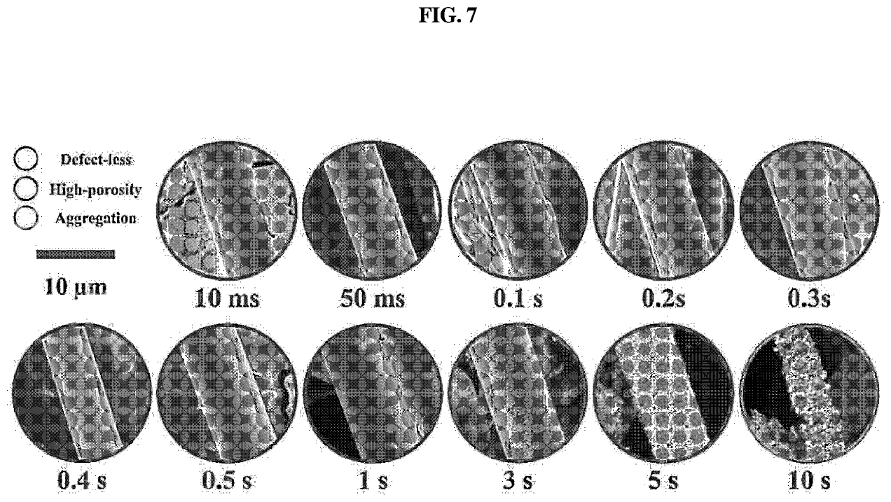

Referring to FIG. 7, an SEM image of a second harvesting structure produced by applying power of 50 W to the base structure for 10 ms to 10 s is shown. As can be seen in FIG. 7, a pore was not formed in the carbon fiber when the power of 50 W was applied for a relatively short time of 10 ms to 1 s. In addition, it was confirmed that when the power of 50 W was applied for 10 s, which is a relatively long time, palladium nitrate coated onto the surface of the carbon fiber was aggregated, so that no pore was formed. On the other hand, when the power of 50 W was applied for a time of 3 s and 5 s, it was confirmed that a plurality of pores were formed in the surface of the carbon fiber.

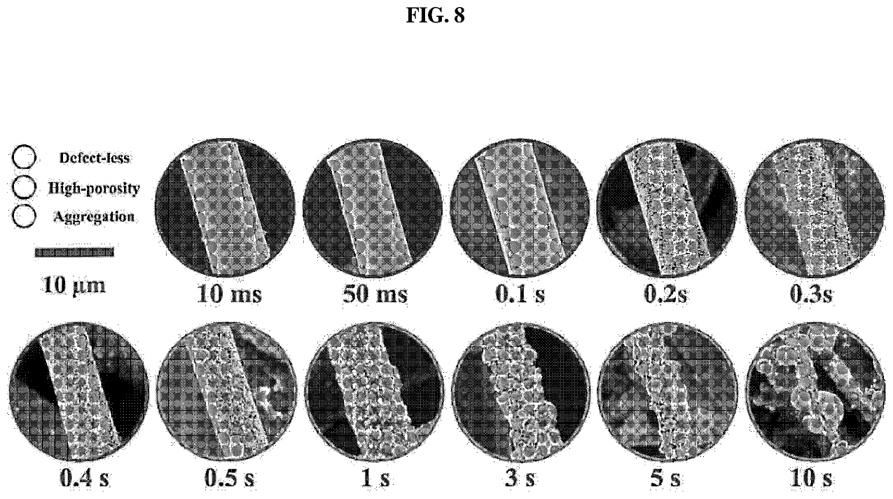

Referring to FIG. 8, an SEM image of a second harvesting structure produced by applying power of 300 W to the base structure for 10 ms to 10 s is shown. As can be seen from FIG. 8, a pore was not formed in the carbon fiber when power of 300 W was applied for a relatively short time of 10 ms to 0.1 s. In addition, it was confirmed that when the power of 300 W was applied for 0.5 s to 10 s, which is a relatively long time, palladium nitrate coated onto the surface of the carbon fiber was aggregated, so that no pore was formed. On the other hand, when the power of 300 W was applied for a time of 0.2 s to 0.4 s, it was confirmed that a plurality of pores were formed in the surface of the carbon fiber.

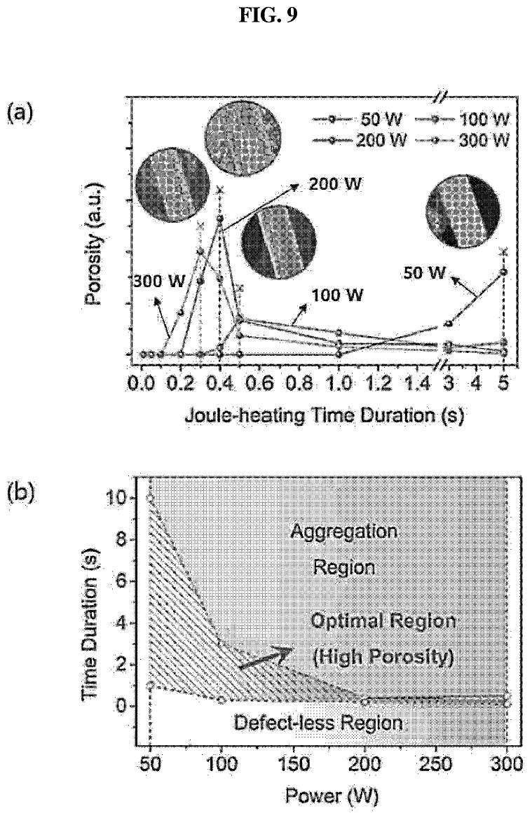

FIG. 9 is a graph showing a change in porosity of the carbon fiber according to the joule-heating conditions in the process of producing the second harvesting structure of the humidity responsive energy harvester according to the embodiment of the present invention.

Referring to FIG. 9(a), porosity (a.u.) of the carbon fiber, which is measured according to power applied to the base structure and a power time duration is shown, and referring to FIG. 9(b), a morphological diagram of the carbon fiber according to the power applied to the base structure and the power time duration is shown.

As can be seen from FIGS. 9(a) and 9(b), the porosity was controlled according to the magnitude of power applied to the base structure and the power time duration. Specifically, when power of 100 W was applied, the porosity of the carbon fiber was improved by controlling the power time duration to longer than 0.4 s and shorter than 1 s. In contrast, when power of 200 W was applied, the porosity of the carbon fiber was improved by controlling the power time duration to longer than 0.3 s and shorter than 0.5 s. In contrast, when power of 300 W was applied, the porosity of the carbon fiber was improved by controlling the power time duration to longer than 0.2 s and shorter than 0.4 s. In particular, it can be seen that when power of 200 W was applied to the base structure for a time longer than 0.3 s and shorter than 0.5 s, the porosity of the carbon fiber was highest.

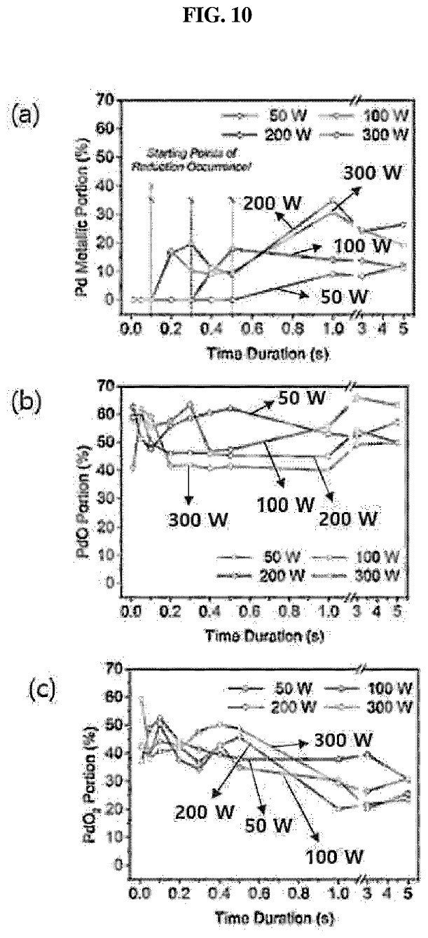

FIG. 10 is a graph showing a change in a chemical composition according to the joule-heating conditions in the process of producing the second harvesting structure of the humidity responsive energy harvester according to the embodiment of the present invention.

Referring to FIGS. 10(a) to 10(c), FIG. 10(a) shows a change in content of palladium metal (Pd metallic portion, %) in the second harvesting structure according to a change in power applied to the base structure and a change in a power time duration, FIG. 10(b) shows a change in a palladium divalent oxide (PdO portion, %), and FIG. 10(c) shows a change in a palladium tetravalent oxide (PdO₂ portion, %).

As can be seen from FIGS. 10(a) to (c), the contents of palladium metal, palladium divalent oxide, and palladium tetravalent oxide in the second harvesting structure were changed depending on the change in the power applied to the base structure and the change in the power time duration.

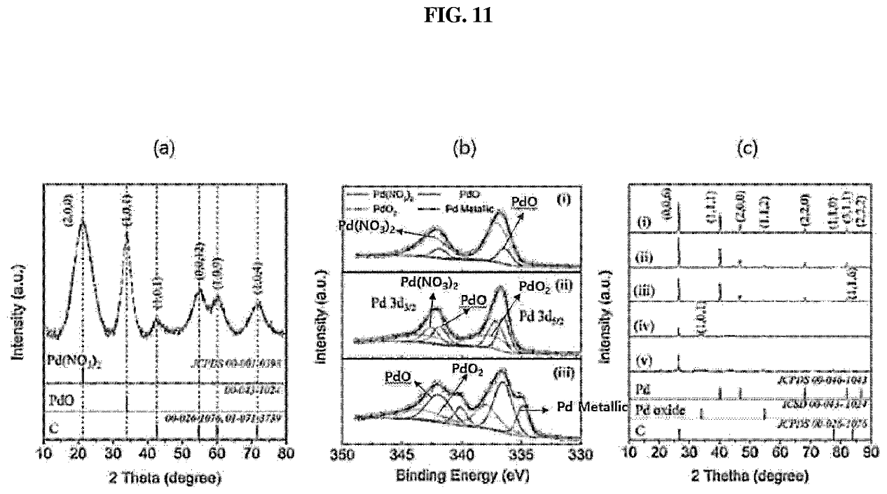

FIG. 11 is a graph showing a change in a chemical composition of the second harvesting structure of the humidity responsive energy harvester according to the embodiment of the present invention.

Referring to FIG. 11(a), an X-ray diffraction (XRD) analysis result for the base structure prepared during the process of producing the second harvesting structure is shown. As can be seen in FIG. 11(a), the base structure included palladium nitrate (Pd(NO₃)₂) and palladium divalent oxide (PdO).

Referring to FIG. 11(b), (i) shows an X-ray photoelectron spectroscope (XPS) analysis result for the base structure, (ii) shows an XPS analysis result of the second harvesting structure produced by applying power of 100 W for 0.2 s, and (iii) shows an XPS analysis result of the second harvesting structure produced by applying power of 200 W for 0.3 s.

Referring to FIG. 11(c), there is shown an XRD analysis for each of a plurality of second harvesting structures after preparing the plurality of second harvesting structures produced by varying the magnitude of power applied to the base structure and the time duration of the power. Specifically, (i) shows a condition in which power of 50 W is applied for 0.2 s, (ii) shows a condition in which power of 50 W is applied for 1 s, (iii) shows a condition in which power of 100 W is applied for 0.5 s, (iv) shows a condition in which power of 200 W is applied for 0.5 s, and (v) shows a condition in which power of 300 W is applied for 0.5 s.

As can be seen from FIGS. 11(b) and 11(c), the palladium divalent oxide (PdO) and the palladium tetravalent oxide (PdO₂) were easily formed from the palladium nitrate even at a low energy of less than 40 J. Specifically, it was confirmed that palladium divalent oxide (PdO) was formed in an amount of 30% or greater, and palladium tetravalent oxide (PdO₂) was formed in an amount of 42% or greater.

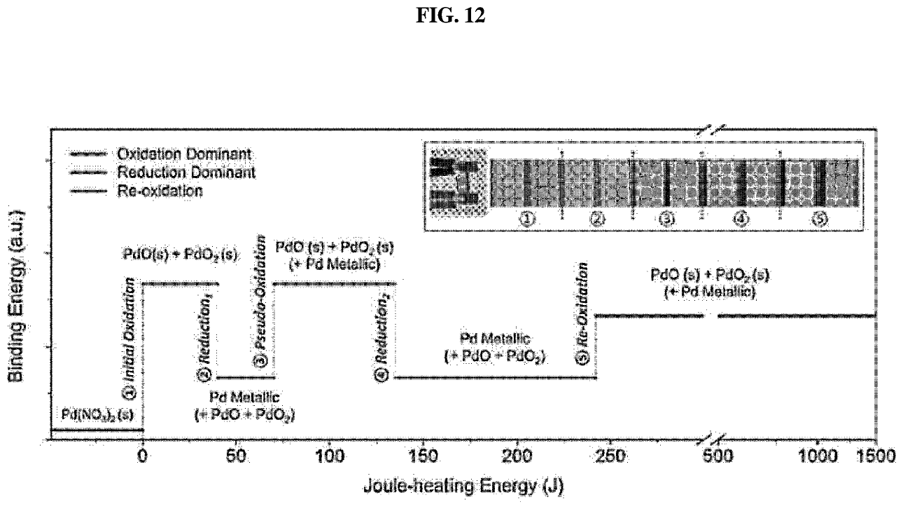

FIG. 12 is a view showing a change in a chemical composition according to energy applied to a base structure during the process of producing the second harvesting structure of the humidity responsive energy harvester according to the embodiment of the present invention.

Referring to FIG. 12, there are shown a graph showing an energy barrier of redox reaction according to joule-heating energy (J) applied to the base structure during the process of producing the second harvesting structure, and an image of palladium divalent oxide (PdO) and palladium tetravalent oxide (PdO₂) which is captured in each step. As can be seen from FIG. 12, since the applied joule-heating energy increased, the oxidation reaction and the redox reaction exhibited, and the different chemical composition in each reaction was observed.

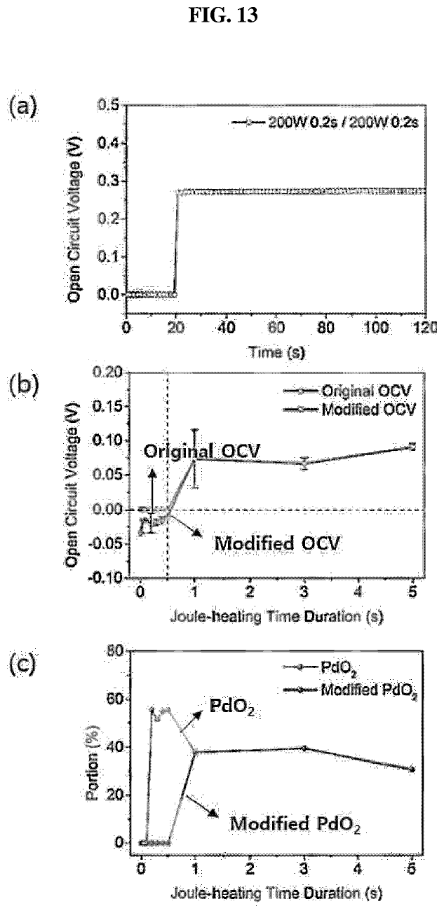

FIG. 13 is a graph showing a change in electrical characteristics according to the energy applied to the base structure during the process of producing the second harvesting structure of the humidity responsive energy harvester according to the embodiment of the present invention.

Referring to FIG. 13(a), there is shown an open circuit voltage (OCV, V) that is measured according to a power application time (Time, s) after performing the joule-heating process of the base structure during the process of producing the second harvesting structure in stages by dividing the joule-heating process into a primary joule-heating step (200 W, 0.2 s) and a secondary joule-heating step (200 W, 0.2 s). Referring to FIG. 13(b), a comparison between an original OCV value and a modified OCV value according to the joule-heating time duration (s) is shown. Referring to FIG. 13(c), an original content of palladium tetravalent oxide (PdO₂ portion, %) and a modified content of palladium tetravalent oxide (modified PdO₂ portion, %) according to the joule-heating time duration (s).

As can be seen from FIGS. 13(a) to 13(c), since the redox reaction induced by H₂O change was highly reversible, it was confirmed that the redox reaction was self-restored to its initial state in an environment where there is no external load. In addition, it was confirmed that the higher the content of palladium tetravalent oxide (PdO₂), the higher the energy generation tendency appeared.

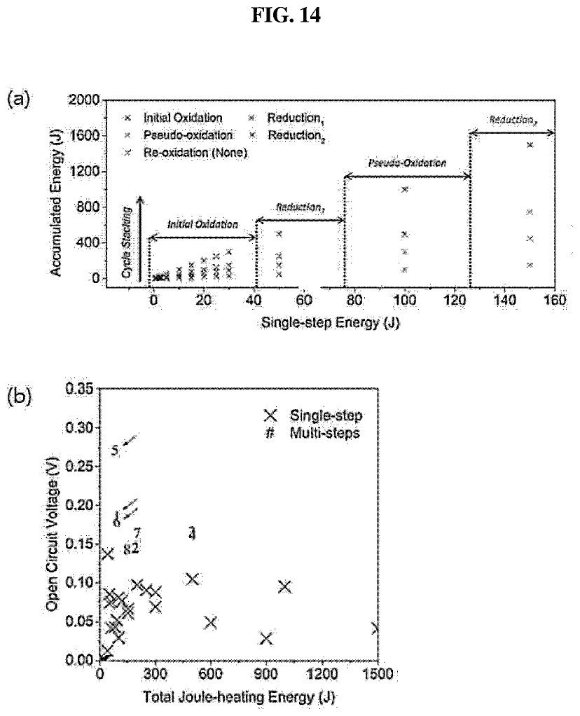

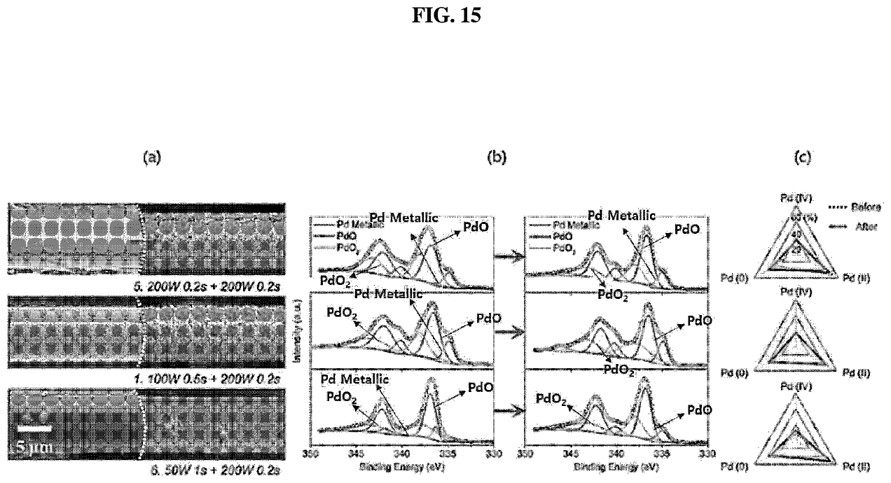

FIGS. 14 and 15 are views showing an influence of stepwise joule-heating during the process of producing the second harvesting structure of the humidity responsive energy harvester according to the embodiment of the present invention.

Referring to FIG. 14(a), accumulated energy (J) according to joule-heating energy (single-step energy, J) applied to the base structure is shown when the second harvesting structure is produced through a single joule-heating on the base structure. As can be seen from FIG. 14(a), the chemical composition was not significantly changed at energy of 100 J or less.

Referring to FIG. 14(b), there is shown an OCV (V) that is measured according to the total joule-heating energy (J) for each of the plurality of second harvesting structure, which is produced under controlled conditions, after variously controlling the joule-heating conditions applied to the base structure. A mark X shown in FIG. 14(b) indicates a second harvesting structure produced in a single joule-heating process, and numbers of 1 to 8 indicate a second harvesting structure produced by performing the primary joule-heating process and the secondary joule-heating process in stages.

As can be seen from FIG. 14(b), the second harvesting structure, which was produced by performing the primary and secondary joule-heating processes in stages under the condition of 200 W-2 s/200 W-2 s, had a high OCV value of about 0.2727 V. In contrast, a secondary harvesting structure, which was produced by performing the primary and secondary joule-heating processes in stages under the condition of 100 W-0.5 s/200 W-0.2 s and the condition of 50 W-1 s/200 W-2 s, had a low OCV value of about 0.1369 V.

Accordingly, in the process of producing the second harvesting structure, it can be seen that the performance of the humidity responsive energy harvester, which was produced by performing a stepwise joule-heating process (e.g., primary joule-heating-secondary joule-heating) on the base structure, was higher than the performance of the humidity responsive energy harvester produced by performing a single joule-heating process.

Referring to FIG. 15(a), there is shown the secondary harvesting structures which are captured under different conditions by varying conditions of the primary joule-heating process and the secondary joule-heating process, when the second harvesting structure is produced by performing the primary joule-heating process and the secondary joule-heating process on the base structure. The specific process condition is 200 W-0.2 s (primary)+200 W-0.2 s (secondary)/100 W-0.5 s (primary)+200 W-0.2 s (secondary)/50 W-1 s (primary)+200 W-0.2 s (secondary).

As can be seen from FIG. 15(a), almost no physical change appeared in the surface of the carbon fiber in the primary joule-heating step, but a plurality of pores were formed in the surface of the carbon fiber in the secondary joule-heating step.

Referring to FIGS. 15(b) and 15(c), there are shown comparisons of chemical compositions for states of the secondary harvesting structure before and after the joule-heating process, after preparing the secondary harvesting structure produced through a stepwise joule-heating process of the primary joule-heating and the secondary joule-heating. The left graph in FIG. 15(b) shows a state before the joule-heating process, and the right graph of FIG. 15(b) shows a state after the joule-heating process.

As can be seen from FIGS. 15(b) and 15(c), as a result of the comparisons before and after the joule-heating process, the compositions of the palladium metal (Pd metallic), the palladium divalent oxide (PdO), and the palladium tetravalent oxide (PdO₂) were not significantly changed.

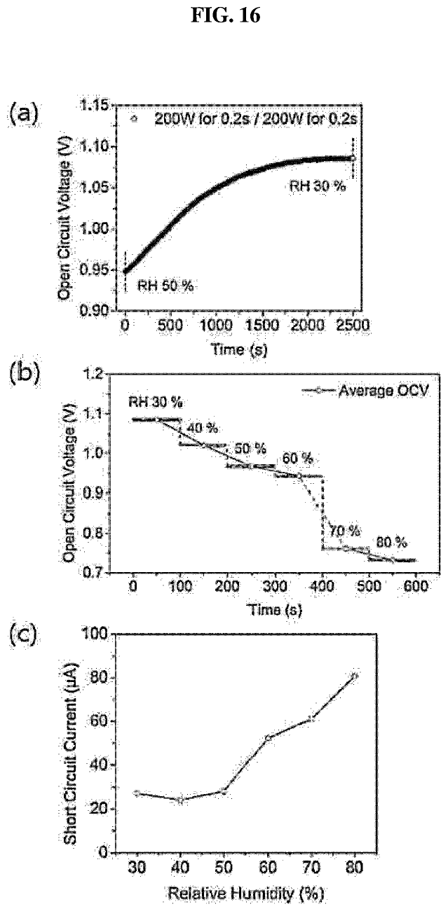

FIG. 16 is a graph showing a change in characteristics according to a humidity environment of the humidity responsive energy harvester according to the embodiment of the present invention.

Referring to FIGS. 16(a) to (c), five humidity responsive energy harvesters, each including the secondary harvesting structures produced under the joule-heating condition of 200 W-0.2 s (primary)+200 W-0.2 s (secondary), were prepared, and an element for connecting the prepared five harvesters in series was prepared.

FIG. 16(a) shows an OCV (V) of the element for a time during which the relative humidity (RH) is changed after the relative humidity (RH) is changed from 50% to 30%. As can be seen from FIG. 16(a), as the relative humidity was changed from 50% to 30%, the OCV value gradually increased from 0.95 V to 1.09 V.

FIG. 16(b) shows an OCV and a short circuit current (SCC) depending on a stepwise relative humidity (RH) condition of 30 to 80%. As can be seen from FIG. 16(b), the OCV value decreased from 1.085 V to 0.732 V as the relative humidity (RH) increased to 30 to 80%. Meanwhile, as can be seen from FIG. 16(c), the SCC value increased from 27.05 μm to 80.76 μm as the relative humidity (RH) increased to 30 to 80%.

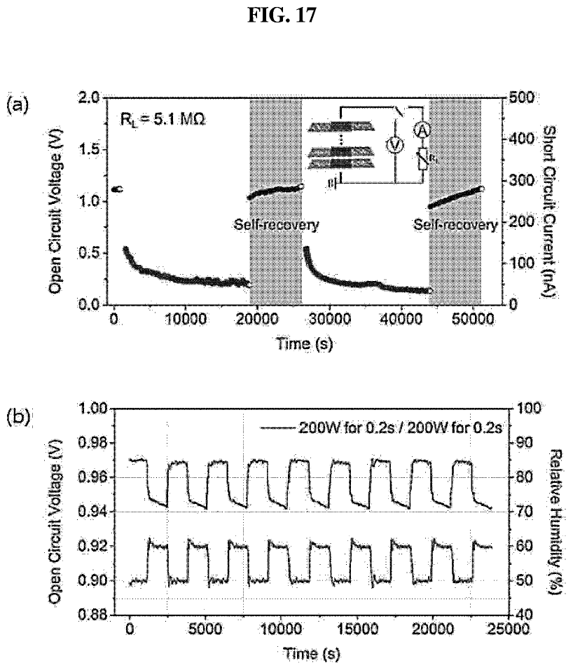

FIG. 17 is a graph showing reliability of the humidity responsive energy harvester according to the embodiment of the present invention.

Referring to FIG. 17(a), there are shown switching characteristics between the OCV and the SCC according to an external load of 5.1 MO in an environment of the relative humidity (RH) of 30%, which are measured in order to measure a self-recovering performance of the element shown in FIG. 16. As can be seen from FIG. 17(a), starting at the voltage level of 1.12 V, sustainable charge generation was achieved for 5 hours, and the voltage is self-recovered within 2 hours by disconnecting the external load and connecting the same again in an OCV measurement mode.

Referring to FIG. 17(b), there is shown an OCV (V) that is measured in an environment in which the relative humidity (RH) of the element shown in FIG. 16 is repeatedly changed to 50 to 60%. As can be seen from FIG. 17(b), the OCV was substantially constant even in the environment in which the relative humidity (RH) is repeatedly changed to 50 to 60%. Accordingly, it can be seen that the humidity responsive energy harvester according to the embodiment of the present invention had high reliability.

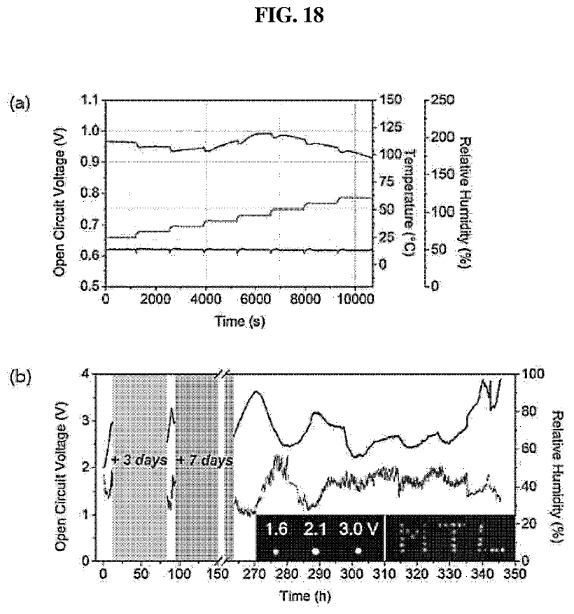

FIG. 18 is a graph showing temperature dependence and stability of the humidity responsive energy harvester according to the embodiment of the present invention.

Referring to FIG. 18(a), there is shown an OCV (V) value that is measured according to a change in temperature from 25° C. to 60° C. in a state where the relative humidity (RH) for the element shown in FIG. 16 is fixed. As can be seen from FIG. 18(a), when humidity is fixed, the OCV value was not significantly changed according to the temperature.

Referring to FIG. 18(b), 12 humidity responsive energy harvesters, each including the secondary harvesting structures produced under the joule-heating condition of 200 W-0.2 s (primary)+200 W-0.2 s (secondary), were prepared, and an element for connecting the prepared 12 harvesters in series was prepared. An OCV (V) for the prepared element was continuously measured for 350 hours. In addition, 31 LEDs having a threshold voltage of 1.6 V were operated through the above-described element.

As can be seen from FIG. 18(b), the OCV was continuously measured for 350 hours, and all 31 LEDs were also operated. Accordingly, it can be seen that the humidity responsive energy harvester according to the embodiment of the present invention has high stability.

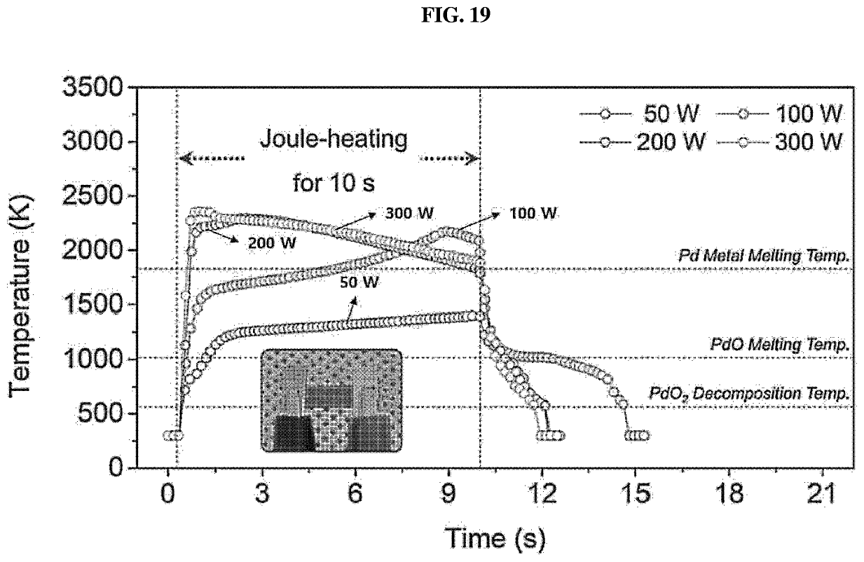

FIG. 19 is a graph showing a temperature profile according to a power application time during the process of producing the second harvesting structure of the humidity responsive energy harvester according to the embodiment of the present invention.

Referring to FIG. 19, there is shown a temperature (K) that is measured according to a power application time (Time, s) at each power by controlling the magnitude of power applied to the base structure to 50 W, 100 W, 200 W, and 300 W. As can be seen from FIG. 19, different temperature profiles were observed according to the magnitude of applied power.

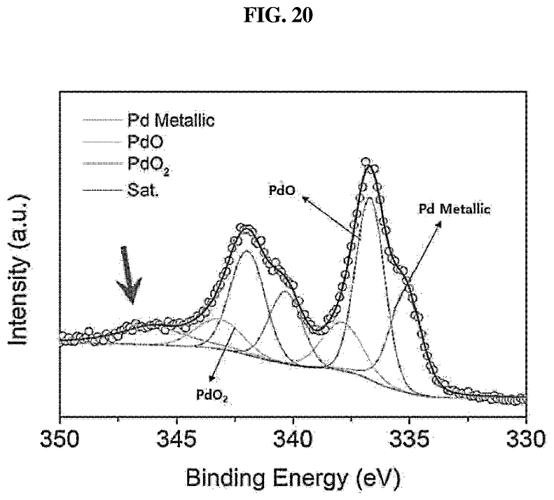

FIG. 20 shows an x-ray photoelectron spectroscope (XPS) peak decomposition of the chemical composition of the second harvesting structure of the humidity responsive energy harvester according to the embodiment of the present invention.

Referring to FIG. 20, XPS peak decomposition for the second harvesting structure is shown. As can be seen from FIG. 20, in case of palladium, a satellite peak frequently exists in a 3d XPS spectrum near binding energy of about 346.3 eV.

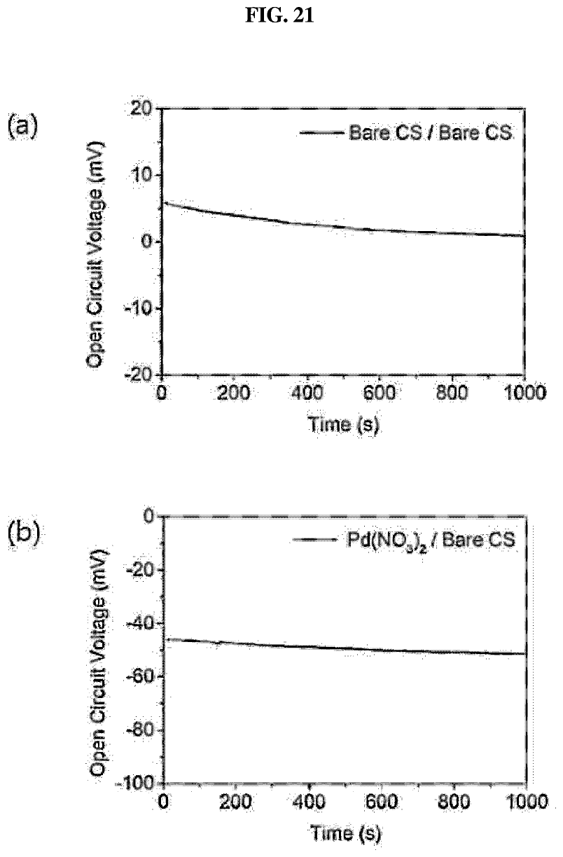

FIG. 21 is a graph of comparing the base structure according to the embodiment of the present invention with a base structure according to a comparative example.

Referring to FIGS. 21(a) and 21(b), there is shown an OCV (mV) that is measured according to a time (s) in a state where an initial relative humidity (RH) and a stimulus relative humidity (RH) are maintained at 50% and 60%, respectively, after preparing a base structure (Bare CS/Bare CS) in which a carbon sheet is stacked according to the comparative example and a base structure (Pd(NO₃)₂/Bare CS) according to an example.

As can be seen from FIGS. 21(a) and 21(b), the OCV value of the base structure according to the comparative example was continuously reduced over time, but the OCV value of the base structure according to the example was maintained substantially constant over time.

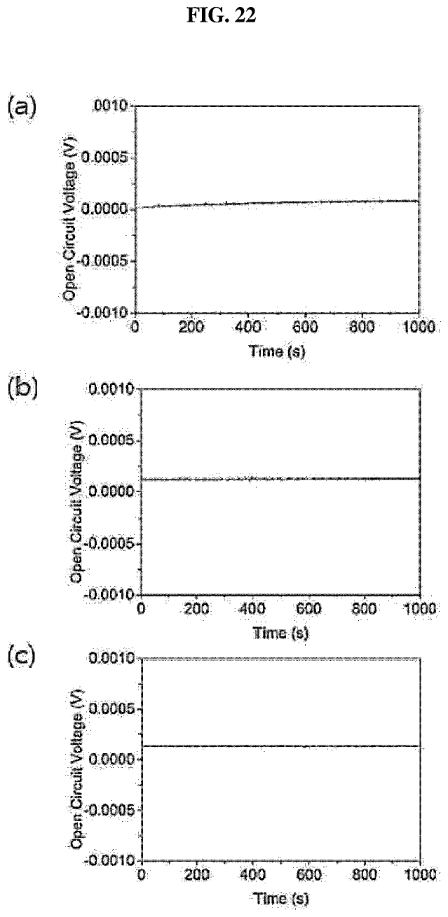

FIG. 22 is a graph of testing solution environment dependence of the humidity responsive energy harvester according to the embodiment of the present invention.

Referring to FIGS. 22(a) to 22(c), a humidity responsive energy harvester including a secondary harvesting structure, which was produced under joule-heating conditions of 200 W-0.2 s (primary)+200 W-0.2 s (secondary), was prepared, and a potential generation test was performed under (a) DI water condition, (b) PSSH solution condition, and (c) sulfonic acid solution conditions. As can be seen from FIGS. 22(a) to 22(c), the potential was generated regardless of environmental conditions of the solution.

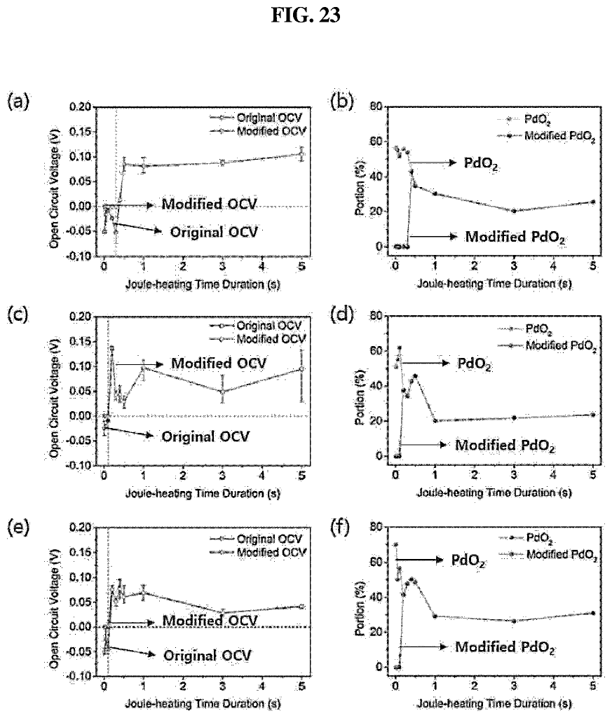

FIG. 23 is a graph showing a change in electrical characteristics and a change in a chemical composition according to the magnitude of power applied to the base structure and a joule-heating time during the process of producing the second harvesting structure of the humidity responsive energy harvesting according to the embodiment of the present invention.

Referring to FIGS. 23(a) to 23(f), there is shown a comparison between an original OCV value and a modified OCV value according to the joule-heating time duration (s), according to the magnitude of power applied to the base structure. In addition, there are shown an original content of palladium tetravalent oxide (PdO₂ portion, %) and a modified content of palladium tetravalent oxide (modified PdO₂ portion, %) according to the joule-heating time duration.

Specifically, FIGS. 23(a) and 23(b) show a case where power of 100 W is applied, FIGS. 23(c) and 23(d) show a case where power of 200 W is applied, and FIGS. 23(e) and 23(f) show a case where power of 300 W is applied.

As can be seen from FIGS. 23(a) to 23(f), in all cases where power of 100 W, 200 W, and 300 W was applied, the higher the content of palladium tetravalent oxide (PdO₂), the higher the energy generation tendency appeared.

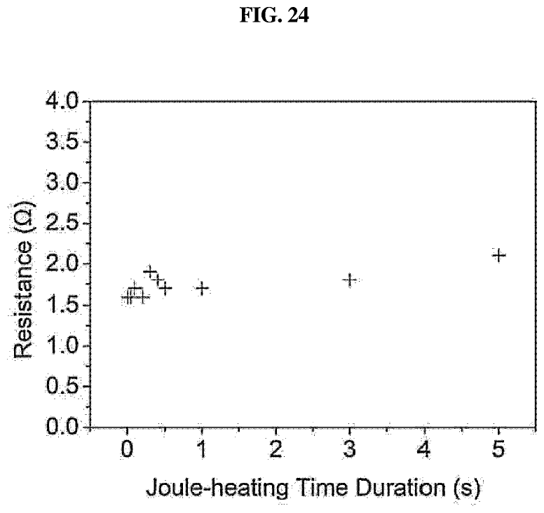

FIG. 24 is a graph showing electrical characteristics of a carbon fiber sheet of the humidity responsive energy harvester according to the embodiment of the present invention.

Referring to FIG. 24, there is shown a resistance (Ω) that is measured according to the joule-heating time duration (s), for the carbon fiber sheet disposed to face the second harvesting structure with the first harvesting structure interposed therebetween. As can be seen from FIG. 24, the resistance of the carbon fiber sheet was maintained substantially constant despite the increase in the joule-heating time duration.

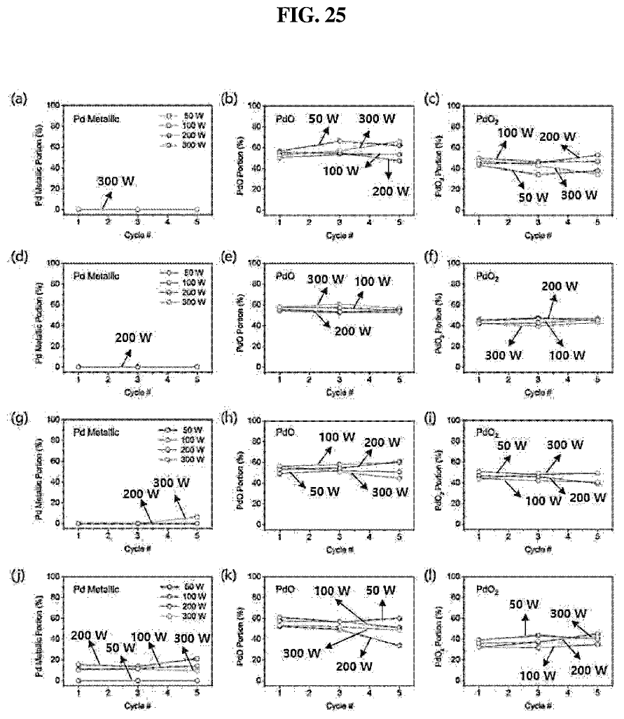

FIG. 25 is graphs of a comparison between chemical compositions according to a joule-heating cycle of the second harvesting structure of the humidity responsive energy harvester according to the embodiment of the present invention.

Referring to FIGS. 25(a) to (l), there are shown a content of palladium metal (Pd metallic portion, %), a content of palladium divalent oxide (PdO portion, %), and the content of palladium tetravalent oxide (PdO₂ portion, %) of each of the second harvesting structures, which are measured after preparing the mutually different second harvesting structures produced by varying the magnitude of power applied to the base structure, the power time duration, and the joule-heating cycle.

Specifically, FIGS. 25(a) to (c) show a condition in which power of 50 W is applied for 0.1 s, FIGS. 25(d) to (f) show a condition in which power of 100 W is applied for 0.05 s, FIGS. 25(g) to (i) show a condition in which power of 200 W is applied for 0.1 s, and FIGS. 25(j) to (l) show a condition in which power of 300 W is applied for 0.5 s. In addition, the joule-heating cycle was performed with 1 stack, 3 stacks, and 5 stacks.

As can be seen from FIG. 25, the content of palladium metal (Pd metallic portion, %), the content of palladium divalent oxide (PdO portion, %), and the content of palladium tetravalent oxide (PdO₂ portion, %) were not significantly changed despite of the change in the magnitude of power, power time duration, and joule-heating cycle.

While the present invention has been described in connection with the embodiments, it is not to be limited thereto but will be defined by the appended claims. In addition, it is to be understood that those skilled in the art can substitute, change or modify the embodiments in various forms without departing from the scope and spirit of the present invention.

### INDUSTRIAL APPLICABILITY

The humidity responsive energy harvester according to the embodiment of the present invention may be used in the field of energy storage devices.

1. A humidity responsive energy harvester comprising:
a substrate structure including a carbon fiber;
a first harvesting structure disposed on the substrate structure and including a polymer that changes a concentration of hydrogen ions in response to humidity; and
a second harvesting structure disposed on the first harvesting structure and including a carbon fiber coated with an active material which includes a composite of a transition metal and an oxide of the transition metal,
wherein when the polymer in the first harvesting structure changes the concentration of hydrogen ions in response to the humidity, energy is generated due to a difference in redox reaction of the second harvesting structure.

2. The humidity responsive energy harvester of claim 1, wherein the active material includes a plurality of oxides of the transition metal, which have mutually different oxidation numbers, and
as a content of the oxide of the transition metal, which has a relatively high oxidation number, increases, an amount of generated energy increases.

3. The humidity responsive energy harvester of claim 2, wherein the active material includes palladium (Pd), palladium divalent oxide (PdO), and palladium tetravalent oxide (PdO₂), and
as a content of the palladium tetravalent oxide (PdO₂) increases, the amount of generated energy increases.

4. The humidity responsive energy harvester of claim 1, wherein the carbon fiber in the second harvesting structure has a porous structure, and as porosity of the carbon fiber increases, an amount of generated energy increases.

5. The humidity responsive energy harvester of claim 1, wherein the polymer includes poly(4-styrenesulfonic acid) (PSSH).

6. A method for manufacturing a humidity responsive energy harvester, the method comprising:
preparing a first harvesting structure that includes a polymer that changes a concentration of hydrogen ions in response to humidity;
joule-heating a base structure including a carbon fiber coated with a precursor material including a transition metal, thereby preparing a second harvesting structure having a chemical composition and a physical structure of a base structure in which a chemical composition and a physical structure of the base structure are changed due to the precursor material; and
bonding a substrate structure that includes the carbon fiber, the first harvesting structure, and the second harvesting structure such that the first harvesting structure is disposed between the substrate structure and the second harvesting structure.

7. The method of claim 6, wherein the preparing of the second harvesting structure includes:
a primary joule-heating step of changing the chemical composition of the base structure; and a secondary joule-heating step of changing the physical structure of the base structure,
wherein in the primary joule-heating step, the precursor material coated on the carbon fiber in the base structure is oxidized to be changed into an active material including a composite of the transition metal and an oxide of the transition metal, and
wherein in the secondary joule-heating step, a liquefied oxide of the transition metal penetrates into the carbon fiber so that a pore is formed in the carbon fiber.

8. The method of claim 7, wherein in the secondary joule-heating step, as a magnitude of power applied to the base structure and a time duration of the power are controlled, porosity of the carbon fiber is controlled.

9. The method of claim 7, wherein the primary joule-heating step is performed prior to the secondary joule-heating step.

10. The method of claim 7, wherein the active material includes a plurality of oxides of the transition metal, which have mutually different oxidation numbers.

11. The method of claim 6, wherein the preparing of the second harvesting structure includes:
preparing a carbon fiber sheet;
providing the precursor material on the carbon fiber sheet to produce the base structure in which a surface of the carbon fiber sheet is coated with the precursor material; and
joule-heating the base structure by forming electrodes on both ends of the base structure, and applying power to the electrodes formed on the both ends.

12. The method of claim 6, wherein the transition metal includes palladium (Pd), and the precursor material includes palladium nitrate (Pd(NO₃)₂).
